(19) United States
(12) Patent Application Publication
(10) Pub. No.: US 2005/0136993 A1
(43) Pub. Date: Jun. 23, 2005

(54) Method of saving power, radio terminal equipment arrangement, cellular core unit, and peripheral unit

(76) Inventors: Harri Lilja, Oulunsalo (FI); Janne Kallio, Pattijoki (FI); Jari Vallstrom, Oulu (FI); Anne Elsila, Oulu (FI); Sanna Raitanen, Oulu (FI)

Correspondence Address: CRAWFORD MAUNU PLLC, 1270 NORTHLAND DRIVE, SUITE 390, ST. PAUL, MN, 55120, US

(21) Appl. No.: 10/745,253

(22) Filed: Dec. 23, 2003

(51) Int. Cl. H04M 1/00; H04B 1/38

(52) U.S. Cl. 455/574; 455/41.2

(57) ABSTRACT

There is provided a method of saving power and a radio terminal equipment arrangement comprising a cellular core unit and at least one peripheral unit. The peripheral unit comprises a control unit for controlling the functions of the peripheral unit, and a transceiver for sending a message for requesting cellular related information to the cellular core unit when an application requiring a cellular connection is activated by the peripheral unit. The cellular core unit is configured to send cellular related information to the peripheral unit when the message for requesting cellular related information has been received, and the control unit for controlling functions of the peripheral unit is configured to notify cellular related information in the peripheral unit based on the received cellular related information from the cellular core unit.

### BACKGROUND OF THE INVENTION

1. Field of the Invention

The invention relates to a method of saving power in a radio terminal equipment arrangement, to a radio terminal equipment arrangement, to a cellular core unit, and to a peripheral unit of a radio terminal equipment arrangement.

2. Description of the Related Art

Mobile devices divided into several parts that are used in various combinations are being developed. Terminals called multipart radio terminals may, for example, include a very small cellular core unit and a number of optimized peripheral units. The core unit of the multipart radio terminal may also be a mobile device including the functionalities of the core unit of a multipart radio terminal. The peripheral units of the multipart radio terminals are optimized for specific tasks and all the peripheral units are connected to a core unit by low power radio frequency (LPRF) connections, such as Bluetooth connections. One of the peripheral units may be optimized for making basic phone calls and another peripheral unit may be optimized for messaging and browsing or for imaging and music, for example. Outside cellular connections, such as GSM (Global System for Mobile Communications) or GPRS (General Packet Radio Service)/EDGE (Enhanced Data rates for GSM Evolution) connections, required by the peripheral units are communicated via the core unit.

Various kinds of cellular related information, such as cellular field strength or quality of a cellular connection, may be indicated in the peripheral units of a multipart radio terminal. This kind of information is needed especially when the core unit is used for connecting the peripheral unit to a cellular network, for example. However, providing cellular related information to the peripheral units increases the power consumption of the multipart radio terminal because the connection between the core unit and the peripheral unit requires a wireless connection like Bluetooth. On the other hand, sometimes there is no need for any cellular related information. Cellular related information is unnecessary when the user of the peripheral unit does not use applications requiring outside cellular connections, for example.

### SUMMARY OF THE INVENTION

According to an aspect of the invention, there is provided a method of saving power in a radio terminal equipment arrangement comprising a cellular core unit and at least one peripheral unit, the cellular core unit communicating with the peripheral unit using a wireless low power radio frequency (LPRF) connection. The method comprises a step of sending, by the cellular core unit, cellular related information to the peripheral unit when an application requiring a cellular connection is active in the peripheral unit, a step of notifying, in the peripheral unit, the cellular related information based on the received cellular related information from the cellular core unit, and a step of interrupting the sending of the cellular related information to the peripheral unit when the application requiring a cellular connection is inactive in the peripheral unit.

According to another aspect of the invention, there is provided a method of saving power in a radio terminal equipment arrangement comprising a cellular core unit and at least one peripheral unit, the cellular core unit communicating with the peripheral unit using a wireless low power radio frequency (LPRF) connection. The method comprises a step of sending, by the peripheral unit, a message for requesting cellular related information to the cellular core unit when an application requiring a cellular connection is activated by the peripheral unit. The method also comprises the steps of sending, by the cellular core unit, cellular related information to the peripheral unit when the message for requesting cellular related information has been received in the cellular core unit, and notifying, in the peripheral unit, cellular related information based on the received cellular related information from the cellular core unit.

According to another aspect of the invention, there is provided a method of saving power in a radio terminal equipment arrangement comprising a cellular core unit and at least one peripheral unit, the cellular core unit communicating with the peripheral unit using a wireless low power radio frequency (LPRF) connection. The method comprises the steps of sending, by the cellular core unit, cellular related information to the peripheral unit when an application requiring a cellular connection is active in the peripheral unit and a command message for requesting the cellular related information is received in the cellular core unit, notifying, in the peripheral unit, cellular related information based on the received cellular related information from the cellular core unit, and interrupting the sending of the cellular related information to the peripheral unit when a command message for interrupting the sending of the cellular related information is received in the cellular core unit.

According to an embodiment of the invention, there is provided a radio terminal equipment arrangement comprising a cellular core unit and at least one peripheral unit. The cellular core unit comprises a control unit for controlling the functions of the cellular core unit, and a transceiver for communicating with the at least one peripheral unit by using a wireless low power radio frequency (LPRF) connection. The peripheral unit comprises a control unit for controlling the functions of the peripheral unit, and a transceiver for communicating with the cellular core unit. The control unit for controlling the functions of the cellular core unit is configured to send cellular related information to the peripheral unit when an application requiring a cellular connection is active in the peripheral unit, and to interrupt the sending of the cellular related information to the peripheral unit when the application requiring a cellular connection is inactive in the peripheral unit, and the control unit for controlling the functions of the peripheral unit is configured to notify cellular related information in the peripheral unit based on the received cellular related information from the cellular core unit.

According to another embodiment of the invention, there is provided a radio terminal equipment arrangement comprising a cellular core unit and at least one peripheral unit. The cellular core unit comprises a control unit for controlling the functions of the cellular core unit, and a transceiver for communicating with the at least one peripheral unit by using a wireless low power radio frequency (LPRF) connection. The peripheral unit comprises a control unit for controlling the functions of the peripheral unit, and a transceiver for sending a message for requesting cellular related information to the cellular core unit when an application requiring a cellular connection is activated by the peripheral unit. The control unit for controlling the functions of the cellular core unit is configured to send cellular related information to the peripheral unit when the message for requesting cellular related information has been received, and the control unit for controlling the functions of the peripheral unit is configured to notify cellular related information in the peripheral unit based on the received cellular related information from the cellular core unit.

According to an embodiment of the invention, there is provided a radio terminal equipment arrangement comprising a cellular core unit and at least one peripheral unit. The cellular core unit comprises a control unit for controlling functions of the cellular core unit, and a transceiver for communicating with the at least one peripheral unit by using a wireless low power radio frequency (LPRF) connection. The peripheral unit comprises a control unit for controlling functions of the peripheral unit, and a transceiver for communicating with the cellular core unit. The control unit for controlling the functions of the cellular core unit is configured to send cellular related information to the peripheral unit when an application requiring a cellular connection is active in the peripheral unit and a command message for requesting the cellular related information is received in the cellular core unit, and to interrupt the sending of the cellular related information to the peripheral unit when a command message for interrupting the sending of the cellular related information is received in the cellular core unit, and the control unit for controlling the functions of the peripheral unit is configured to notify cellular related information in the peripheral unit based on the received cellular related information from the cellular core unit.

According to another aspect of the invention, there is provided a cellular core unit of a radio terminal equipment arrangement, comprising communicating means for communicating with at least one peripheral unit of the radio terminal equipment arrangement by using a wireless low power radio frequency (LPRF) connection, and controlling means for controlling functions of the cellular core unit, sending cellular related information to the peripheral unit when an application requiring a cellular connection is active in the peripheral unit, and interrupting the sending of the cellular related information to the peripheral unit when the application requiring a cellular connection is inactive in the peripheral unit.

According to another aspect of the invention, there is provided a cellular core unit of a radio terminal equipment arrangement, comprising controlling means for controlling functions of the cellular core unit, and communicating means for communicating with at least one peripheral unit of the radio terminal equipment arrangement by using a wireless low power radio frequency (LPRF) connection, receiving a message for requesting cellular related information from the peripheral unit, and sending cellular related information to the peripheral unit when the message for requesting cellular related information has been received.

According to another aspect of the invention, there is provided a cellular core unit of a radio terminal equipment arrangement, comprising communicating means for communicating with at least one peripheral unit of the radio terminal equipment arrangement by using a wireless low power radio frequency (LPRF) connection, and controlling means for controlling functions of the cellular core unit, sending cellular related information to the peripheral unit when an application requiring a cellular connection is active in the peripheral unit and a command message for requesting the cellular related information is received in the cellular core unit, and interrupting the sending of the cellular related information to the peripheral unit when a command message for interrupting the sending of the cellular related information is received in the cellular core unit.

According to another aspect of the invention, there is provided a peripheral unit of a radio terminal equipment arrangement, comprising controlling means for controlling functions of the peripheral unit, and communicating means for communicating with a cellular core unit of the radio terminal equipment arrangement by using a wireless low power radio frequency (LPRF) connection. The communicating means are further configured to receive cellular related information from the cellular core unit when an application requiring a cellular connection is active in the peripheral unit, and to interrupt the sending of the cellular related information to the peripheral unit when the application requiring a cellular connection is inactive-in the peripheral unit, and the controlling means are configured to notify cellular related information in the peripheral unit based on the received cellular related information from the cellular core unit.

According to yet another aspect of the invention, there is provided a peripheral unit of a radio terminal equipment arrangement, comprising controlling means for controlling functions of the peripheral unit, and communicating means for communicating with a cellular core unit of the radio terminal equipment arrangement by using a wireless low power radio frequency (LPRF) connection, and sending a message for requesting cellular related information to the cellular core unit when an application requiring a cellular connection is activated by the peripheral unit. The controlling means are further configured to notify cellular related information based on the received cellular related information from the cellular core unit.

Embodiments of the invention provide several advantages. Power consumption is reduced and thus, operation times are increased. Cellular related information is received only when needed.

### BRIEF DESCRIPTION OF THE DRAWINGS

In the following, the invention will be described in greater detail with reference to the preferred embodiments and the accompanying drawings, in which

FIG. 1 shows an example of a structure of a radio system;

FIG. 2 shows an example of a structure of a radio terminal equipment arrangement;

FIG. 3 shows an example of a method of saving power in a radio terminal equipment arrangement; and

FIGS. 4, 5 and 6 show further examples of a method of saving power in a radio terminal equipment arrangement.

### DETAILED DESCRIPTION OF THE PREFERRED EMBODIMENTS

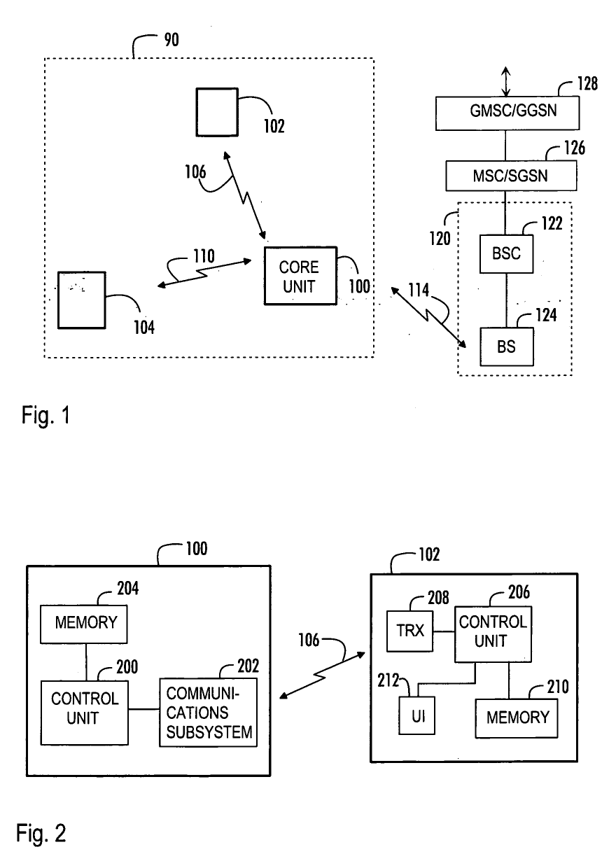

With reference to FIG. 1, let us examine an example of a structure of a radio system to which the preferred embodiments of the invention can be applied. The radio system can be based on, for example, GSM (Global System for Mobile Communications), WCDMA (Wideband Code Division Multiple Access) or CDMA (Code Division Multiple Access). A radio terminal equipment arrangement 90 in FIG. 1 comprises a cellular core unit 100 and a number of optimized peripheral units 102, 104. The radio terminal equipment arrangement 90 is a multipart radio terminal, for example.

A cellular network may correspond to the combined structure of the GSM (Global System for Mobile Communications) and GPRS (General Packet Radio Service) systems, for example. GSM network elements are responsible for the implementation of circuit-switched connections, and GPRS network elements are responsible for the implementation of packet-switched connections, some of the network elements, however, being shared by both systems.

A center 126 represents a mobile services switching center (MSC) and a serving GPRS support node (SGSN) that enable circuit-switched and packet switched signalling, respectively, in the radio system. The cellular network may comprise a gateway unit 128, which is represented by a gateway mobile service switching center (GMSC) and a gateway GPRS support node (GGSN). GMSC attends to the circuit-switched connections between the cellular network and external networks, such as a public land mobile network (PLMN) or a public switched telephone network (PSTN), and GGSN attends to the packet-switched connections between the cellular network and external networks, such as the Internet.

The center 126 controls a radio access network (RAN) 120, which may comprise at least one base station controller 122 controlling at least one base station 124. The base station controller 122 can also be called a radio network controller, and the base station 124 can be called node B. The radio terminal equipment 100 of the radio terminal equipment arrangement 90 may communicate with at least one base station 124 over a radio interface.

The cellular core unit 100 of the radio terminal equipment arrangement 90 is a small cellular core unit with no display and with minimal user interface parts, for example. Basic phone calls cannot be made or answered by the cellular core unit 100 alone, for example, because it lacks a user interface or the user interface part is very minimal. The cellular core unit 100 may be a “dummy black-box device”, almost invisible to the user, and therefore it may not indicate incoming calls or SMS (Short Message Service) messages, for example. In practice, the cellular core unit 100 is placed in a user's handbag, belt or a pocket, for example. It is also possible, that the cellular core unit 100 is a mobile device connected to a certain peripheral unit 102, 104.

The peripheral units 102, 104 in the radio terminal equipment arrangement 90 may be optimized for specific tasks. One of the peripheral units is optimized for making basic phone calls while another peripheral unit is optimized for messaging and browsing or for image processing and music, for example. Data may be stored in the peripheral unit's own databases. The peripheral units 102, 104 communicate with the cellular core unit 100 over low-power radio frequency (LPRF) connections 106, 110, such as Bluetooth or WLAN (Wireless Local Area Network) connections. The cellular core unit 100, on the other hand, is configured to communicate with other systems, such as the Internet, for example with LPRF connections and with GSM/GPRS/EDGE connections 114 as well. It is possible that the peripheral units 102, 104 also communicate with other systems over GSM/GPRS/EDGE connections, for example. It is also possible that the peripheral units 102, 104 are configured to establish outside LPRF connections, such as WLAN connections, to other systems. Also, the cellular core unit 100 may establish connections between the peripheral units 102, 104 and other systems, such as the Internet or other radio terminals, via a cellular network by using a GSM or a GPRS/EDGE connection 114, for example.

The applications used in the radio terminal equipment arrangement 90 may be stored in the memory of the cellular core unit 100 or in the peripheral units 102, 104. The applications that are in the peripheral units 102, 104 may be used with or without a connection to the cellular core unit 100.

In an embodiment of the invention, the cellular core unit 100 comprises controlling means for controlling functions of the cellular core unit, and communicating means for communicating with at least one peripheral unit 102, 104 of the radio terminal equipment arrangement 90 by using a wireless low power radio frequency (LPRF) connection. The controlling means are further configured to send cellular related information to the peripheral unit 102, 104 when an application requiring a cellular connection is active in the peripheral unit 102, 104 and interrupt the sending of the cellular related information when the application requiring cellular connection is inactive in the peripheral unit 102, 104.

In an embodiment, the peripheral unit of a radio terminal equipment arrangement comprises controlling means for controlling functions of the peripheral unit, and communicating means for communicating with a cellular core unit of the radio terminal equipment arrangement by using a wireless low power radio frequency (LPRF) connection. The communicating means are further configured to receive cellular related information from the cellular core unit when an application requiring a cellular connection is active in the peripheral unit, and the controlling means are configured to notify the cellular related information in the peripheral unit based on the received cellular related information from the cellular core unit.

The controlling means for controlling the functions of the cellular core unit 100 and the peripheral unit 102, 104 include control units. The communicating means may include transmitting and receiving elements providing wireless connections over short range or long-range distances.

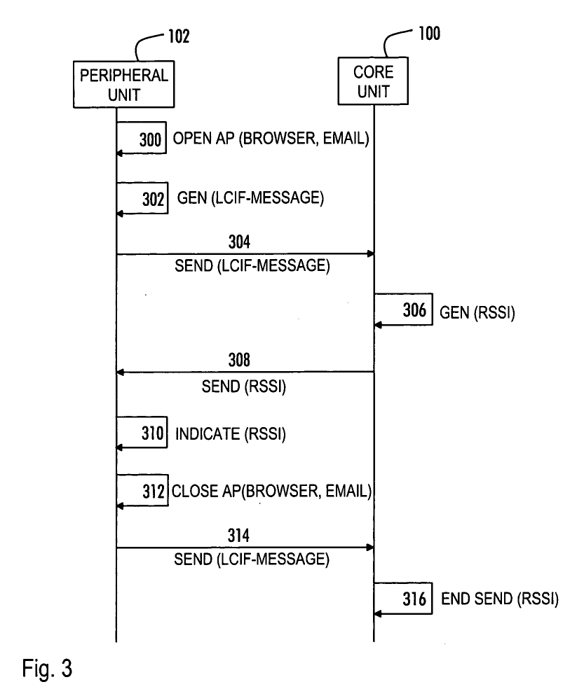

An embodiment of the invention is generally described in FIG. 2. A cellular core unit 100 of a radio terminal equipment arrangement comprises at least a control unit 200 for controlling the functions of the cellular core unit 100, and the cellular core unit 100 is configured to communicate with one or more peripheral units 102 by using wireless low-power radio frequency (LPRF) connections 106.

The cellular core unit 100 may also comprise the following elements: a memory 204 and a communications subsystem 202. The peripheral unit 102 may comprise a transceiver 208 for communicating with the cellular core unit 100, a control unit 206 for controlling the functions of the peripheral unit 102, a memory 210 and a user interface 212.

The control units 200, 206 of the cellular core unit 100 and the peripheral unit 102 refer to blocks controlling the operation of the devices, and are nowadays usually implemented as a processor and software, but different hardware implementations are also feasible, e.g. a circuit built of separate logics components or one or more client-specific integrated circuits (Application-Specific Integrated Circuit, ASIC). A hybrid of these implementations is also feasible. The communications subsystem 202 controls the communication of the cellular core unit 100. The user interface 212 of the peripheral unit 102 is an interface via which the user can interact with the software of the peripheral unit 102 and with the cellular core unit 100 as well. The user interface 212 may comprise a display. In addition, the user interface 212 may include a loudspeaker and a keypad part. Depending on the type of the device, there may be different user interface parts, and the number of such parts may vary.

In an embodiment, the control unit 200 for controlling the functions of the cellular core unit 100 is configured to send cellular related information to the peripheral unit 102 only when an application requiring a cellular connection is active in the peripheral unit 102. The sending of the cellular related information is thus interrupted when the application requiring a cellular connection is inactive. The control unit 206 for controlling the functions of the peripheral unit 102 is configured to notify the cellular related information in the peripheral unit 102 based on the received cellular related information from the cellular core unit 100.

It is possible that a peripheral unit 102 that is optimized for browsing also includes many applications that need no connection to the cellular core unit 100 at all. However, the applications that need to use the cellular core unit 100 as a GPRS modem, e.g. they require a cellular connection, may include a WWW (World Wide Web) Browser or an Email application, for example. The application may also be an application for making basic phone calls, for example. There may also be many different applications, which require a connection to the cellular core unit 100, but need no cellular connection. Such applications comprise calendars, To-do applications and applications requiring core unit file access, for example.

The application may be active in the peripheral unit 102 when it is opened in the peripheral unit 102, for example. An application for making basic phone calls may be active when a screen saver mode is off in the peripheral unit 102. When a WWW Browser is opened in the peripheral unit 102, for example, the cellular core unit 100 starts sending cellular related information to the peripheral unit 102. The cellular related information comprises cellular field strength data, cellular network identifiers, network cell broadcast data or cellular connection quality data, for example. Also, before making a basic phone call, the user may wish to check the connection quality data or cellular field strength information.

In an embodiment, the cellular core unit 100 detects whether the application requiring cellular connection is active or inactive based on communication between the cellular core unit 100 and the peripheral unit 102. The communication between the cellular core unit 100 and the peripheral unit 102 may be in the form of specific command messages, such as AT (Attention) commands over Bluetooth or WLAN connections, for example. In an embodiment, the control unit 206 for controlling the functions of the peripheral unit 102 is configured to send a message for requesting cellular related information to the cellular core unit 100 when an application requiring a cellular connection is activated. The message for requesting the cellular related information may be a local connectivity interface message, for example. The local connectivity interface message may be any message that is sent over an LPRF connection. The local connectivity interface message may be a request, a response or an indication/notification message, for example. The local connectivity interface messages may be sent by using IP (Internet Protocol)/UDP (User Datagram Protocol) or IP/TCP (Transmission Control Protocol) protocols or by using Bluetooth techniques, for example. The local connectivity message may include the name of the message, the type and the length of the message, a data part or any combination thereof. It is also possible that the peripheral unit 102 sends a dial-up command for connecting to a given WWW service, for example, when a browser application is active and the cellular core unit 100 detects that the application requiring a cellular connection is active based on the received dial-up command. Such a dial-up command may be, for example, a command to request a dial-up connection establishment. Another example of such a dial-up command is a message that is sent via a dial-up connection. Such messages are for example AT commands: GPRS attach +CGATT and GPRS PDP context activation +CGACT, which are described in GSM specifications: 3GPP TS 07.07 V7.80 (2003-03), pages 95-96.

The cellular related information may be in an RSSI (Receiving Signal Strength Indicator) message that provides radio carrier signal levels. The cellular core unit 100 receives the RSSI information from the cellular network and then forwards it to the peripheral unit 102. The peripheral unit 102 is configured to notify the received cellular related information on a display 212 of the peripheral unit 102, for example. It is possible that more than one kind of cellular related information is indicated on the display of the peripheral unit 102 at the same time.

In an embodiment, the cellular core unit 100 sends the cellular related information periodically when the application requiring a cellular connection is active in the peripheral unit. The cellular related information may be sent in every fourth second, for example. In an embodiment, the control unit for controlling the functions of the cellular core unit 100 is further configured to detect a change in cellular connection quality, and send the cellular related information only when a change in cellular connection quality has been detected. Thus, it is possible that the cellular related information is sent only when certain changes in cellular connection quality have occurred and when the application requiring a cellular connection is active.

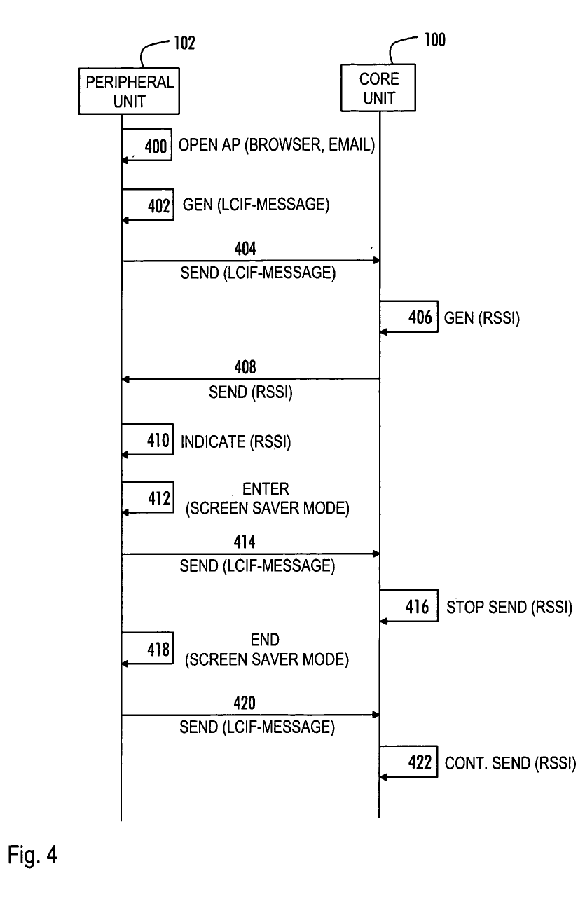

Next, different embodiments of a method of saving power in a radio terminal equipment arrangement will be discussed. FIG. 3 shows an example of a method of saving power in a radio terminal equipment arrangement comprising a cellular core unit and at least one peripheral unit, the cellular core unit communicating with the peripheral unit using a wireless low power radio frequency (LPRF) connection. In FIG. 3, the first vertical line PERIPHERAL UNIT 102 denotes communication originating from the peripheral unit and measures taken by the peripheral unit. The second vertical line CORE UNIT 100 denotes communication of the cellular core unit and measures taken by the cellular core unit.

In 300, an application requiring a cellular connection is activated by the peripheral unit. The peripheral unit may be specified for browsing, and the application may thus then be a WWW Browser or an Email application, for example. Next, in 302, a message for requesting cellular related information, ample. Next, in 302, a message for requesting cellular related information, such as a local connectivity interface message, is generated by the peripheral unit. In 304, the message for requesting cellular related information is sent to the cellular core unit over a Bluetooth or WLAN connection, for example. The message for requesting cellular related information may also be a dial-up command message, which may be sent when a given URL (Uniform Resource Locator) address is entered into the browser application, for example. Thus, it may be that the cellular related information is requested based on the sent dial-up command message and the sending of the cellular related information is stopped based on ending of the established dial-up connection.

In 306, the cellular related information is generated by the cellular core unit. The cellular related information may be received from the cellular network in the form of RSSI information, for example. The cellular related information, in a RSSI message, for example, is sent to the peripheral unit in 308. Next, in 310, the cellular related information is notified in the peripheral unit based on the received cellular related information from the cellular core unit. The cellular related information notified in the peripheral unit may be cellular field strength data, for example. This sending of the RSSI information may continue periodically, in given periods of time, and the peripheral unit may keep updating the received RSSI information indicated in the peripheral unit until the process enters step 312.

In 312, the application requiring cellular related information, such as the WWW Browser or the Email application, becomes inactive. The peripheral unit may close the application, for example. In 314, based on the application requiring cellular related information being closed, the peripheral unit may send a message for requesting the cellular core unit to stop sending the cellular related information to the cellular core unit. The message may be a local connectivity interface message, for example. It is also possible that the message is a dial-up disconnect message, for example. Finally, in 316, the cellular core unit, based on the received message from the peripheral unit, for example, stops sending the cellular related information.

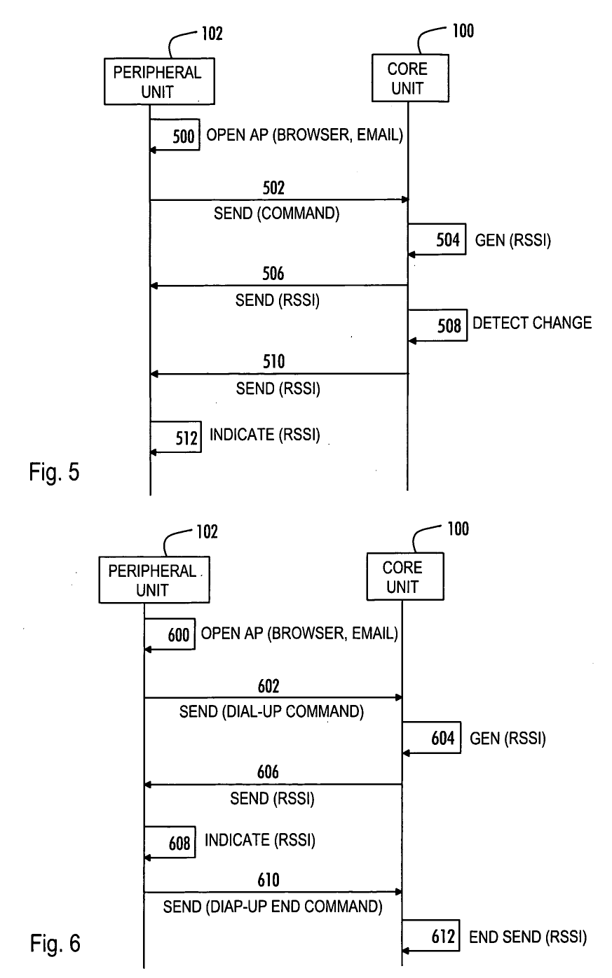

FIG. 4 shows another example of a method of saving power in a radio terminal equipment arrangement. Also, in FIG. 3, the first vertical line PERIPHERAL UNIT 102 denotes communication originating from the peripheral unit and measures taken by the peripheral unit. The second vertical line CORE UNIT 100 denotes communication of the cellular core unit and measures taken by the cellular core unit.

The first steps from 400 to 410 proceed as in the method described in FIG. 3. In 400, the peripheral unit activates an application requiring a cellular connection. In 402, a message for requesting cellular related information is generated by the peripheral unit and in 404, the message for requesting cellular related information is sent to the cellular core unit. In 406, the cellular related information, here RSSI information, is generated by the cellular core unit. The RSSI information is sent to the peripheral unit in 408 and finally, in 410, the RSSI information is notified in the peripheral unit.

In the embodiment of FIG. 4, a situation where the peripheral unit enters an inactive mode takes place next. The inactive mode may be a screen saver mode, for example. The user of the peripheral unit may not have actively used the peripheral unit for a given period of time, which may lead to a situation where the peripheral unit enters the screen saver mode. The inactive mode may also be entered based on detecting a cover closing in a peripheral unit, for example. It may be that the user wishes to stop using the peripheral unit for a while and closes a cover of the display of the device, for example, which may then lead to the peripheral unit entering the inactive mode. In 412, the peripheral unit enters the screen saver mode. Next, in 414, the peripheral unit sends a message for pausing the sending of the cellular related information based on the peripheral unit entering the screen saver mode. When the screen saver mode is on, there is no need to receive any cellular related information since the user may not be using the device at that time. In 416, the cellular core unit stops sending the RSSI information based on the received message from the peripheral unit.

Next, in 418, the screen saver mode ends. The user of the peripheral unit may have continued the browsing, for example, and the screen saver mode ends because of that. As the inactive mode, such as the screen saver mode, ends, the peripheral unit may send a message for continuing the sending of the RSSI information. In 420, the message for continuing the sending of the RSSI information is sent by the peripheral unit. The message for pausing the sending of the cellular related information and the message for continuing the sending of the cellular related information may be in the form of a local connectivity interface message, for example. In 422, the cellular core unit continues sending the RSSI information to the peripheral unit based on the received message for continuing the sending of the cellular related information.

FIG. 5 shows yet another example of a method of saving power in a radio terminal equipment arrangement. Also, in FIG. 5, the first vertical line PERIPHERAL UNIT 102 denotes communication originating from the peripheral unit and measures taken by the peripheral unit. The second vertical line CORE UNIT 100 denotes communication of the cellular core unit and measures taken by the cellular core unit.

In 500, an application requiring a cellular connection is opened in the peripheral unit. In 502, an AT command acting as a message for requesting cellular related information is sent to the cellular core unit, and in 504, an RSSI information message is generated in the cellular core unit. In 506, the RSSI information message is sent to the peripheral unit and the cellular related information is notified in the peripheral unit based on the received RSSI information message. Unlike in the above examples, the sending of the RSSI information is not repeated periodically after this in this embodiment.

In this embodiment, the sending of the cellular related information is repeated only when a change in cellular connection quality is detected in the cellular core unit. In 508, the change in cellular connection quality is detected in the cellular core unit. The change in cellular connection quality may be detected if one or more measures of the cellular connection quality received in the cellular core unit changes by a given amount. The change in cellular connection quality may not be detected when only minor changes in the cellular connection quality take place, for example. The measures of the cellular connection quality may be based on the RSSI information received from the cellular network.

In 510, the RSSI information message is sent to the peripheral unit as a result of detecting a change in cellular connection quality in 508. Finally, in 512, the cellular related information notified earlier in the peripheral unit is updated and notified in the peripheral unit based on the received RSSI information message.

FIG. 6 shows another example of a method of saving power in a radio terminal equipment arrangement. Also, in FIG. 6, the first vertical line PERIPHERAL UNIT 102 denotes communication originating from the peripheral unit and measures taken by the peripheral unit. The second vertical line CORE UNIT 100 denotes communication of the cellular core unit and measures taken by the cellular core unit.

In 600, an application requiring a cellular connection is opened in the peripheral unit. In 602, a command message for requesting cellular related information, such as a Bluetooth dial-up command message, is sent to the cellular core unit. Dial-up command messages may be used in establishing GPRS connections when a user of the peripheral unit wishes to browse the Internet, for example. In this embodiment, the cellular core unit makes a decision of sending the RSSI information to the peripheral unit based on not only the application requiring a cellular connection being active but also on the received dial-up command message. Thus, when an application requiring a cellular connection is active in the peripheral unit and a dial-up command message is received in the cellular core unit, only then, in 604, an RSSI information message is generated in the cellular core unit and in 606, the RSSI information message is sent to the peripheral unit. The cellular core unit thus interprets the received dial-up command message being also the message for requesting cellular related information. In 608, the cellular related information is notified in the peripheral unit based on the received RSSI information message.

In the embodiment of FIG. 6, the sending of the RSSI information is continued until a command message for interrupting the sending of the cellular related information, such as a Bluetooth dial-up command message, is received in the cellular core unit. The user of the device may choose to disconnect from the Internet, for example, and that may result in the cellular core unit receiving a command message for interrupting the sending of the cellular related information. It is also possible, that for the dial-up connection an inactivity timer has been set, that is, the command message for interrupting the sending of the RSSI information is sent after a given period of time has passed without user action. In 610, the peripheral unit sends the command message for interrupting the sending of the cellular related information and in 612, the cellular core unit stops sending the RSSI information based on the received command message from the peripheral unit. Thus, the application requiring a cellular connection may still be open when the sending of the RSSI information is interrupted. It is also possible, that the inactivity timer is implemented in the cellular core unit. Thus, when the inactivity timer expires the cellular core unit stops sending the RSSI information based on the expired timer and no command messages for interrupting the sending of the cellular related information are needed.

Even though the invention is described above with reference to examples according to the accompanying drawings, it is clear that the invention is not restricted thereto but can be modified in several ways within the scope of the appended claims.

1. A method of saving power in a radio terminal equipment arrangement comprising: a cellular core unit and at least one peripheral unit, the cellular core unit communicating with the peripheral unit using a wireless low 5 power radio frequency (LPRF) connection, the method comprising:
sending, by the cellular core unit, cellular related information to the peripheral unit when an application requiring a cellular connection is active in the peripheral unit;
notifying, in the peripheral unit, cellular related information based on the received cellular related information from the cellular core unit; and
interrupting the sending of the cellular related information to the peripheral unit when the application requiring a cellular connection is inactive in the peripheral unit.

2. The method of claim 1, the method further comprising detecting, by the cellular core unit, when the application requiring a cellular connection is active in the peripheral unit based on communication between the peripheral unit and the cellular core unit.

3. The method of claim 2, wherein the communication between the cellular core unit and the peripheral unit comprises sending command messages between the peripheral unit and the cellular core unit.

4. The method of claim 2, wherein the command messages sent between the peripheral unit and the cellular core unit are local connectivity interface messages or dial-up command messages.

5. The method of claim 1, the method further comprising detecting, by the cellular core unit, a change in cellular connection quality, and sending cellular related information when a change in cellular connection quality has been detected.

6. The method of claim 1, wherein the cellular related information comprises cellular field strength data, a cellular network identifier, network cell broadcast data, or cellular connection quality data.

7. A method of saving power in a radio terminal equipment arrangement comprising: a cellular core unit and at least one peripheral unit, the cellular core unit communicating with the peripheral unit using a wireless low power radio frequency (LPRF) connection, the method comprising:
sending, by the peripheral unit, a message for requesting cellular related information to the cellular core unit when an application requiring a cellular connection is activated by the peripheral unit;
sending, by the cellular core unit, cellular related information to the peripheral unit when the message for requesting cellular related information has been received in the cellular core unit; and
notifying, in the peripheral unit, cellular related information based on the received cellular related information from the cellular core unit.

8. The method of claim 7, the method further comprising sending the cellular related information periodically to the peripheral unit when the message for requesting cellular related information has been received in the cellular core unit.

9. The method of claim 7, the method further comprising sending, by the peripheral unit, a message for pausing the sending of the cellular related information to the cellular core unit when the peripheral unit enters an inactive mode.

10. The method of claim 9, the method further comprising sending, by the peripheral unit, a message for continuing the sending of the cellular related information to the cellular core unit when the inactive mode ends.

11. The method of claim 9, wherein the inactive mode is a screen saver mode.

12. The method of claim 8, the method comprising detecting entering the inactive mode based on detecting closing of a cover of the peripheral unit.

13. The method of claim 7, the method further comprising sending, by the peripheral unit, a message for stopping the sending of the cellular related information to the cellular core unit when the application requiring a cellular connection is closed.

14. The method of claim 7, wherein the cellular related information is in an RSSI (Receiving Signal Strength Indicator) message, the RSSI message comprising cellular field strength data, and the step of notifying cellular related information comprises notifying cellular field strength data based on the received RSSI message.

15. The method of claim 7, wherein the application requiring a cellular connection is a WWW (World Wide Web) Browser or an Email application.

16. A method of saving power in a radio terminal equipment arrangement comprising: a cellular core unit and at least one peripheral unit, the cellular core unit communicating with the peripheral unit using a wireless low power radio frequency (LPRF) connection, the method comprising:
sending, by the cellular core unit, cellular related information to the peripheral unit when an application requiring a cellular connection is active in the peripheral unit and a command message for requesting the cellular related information is received in the cellular core unit;
notifying, in the peripheral unit, cellular related information based on the received cellular related information from the cellular core unit; and
interrupting the sending of the cellular related information to the peripheral unit when a command message for interrupting the sending of the cellular related information is received in the cellular core unit.

17. The method of claim 16, wherein the command messages for requesting the cellular related information and interrupting the sending of the cellular related information are Bluetooth dial-up command messages between the peripheral unit and the cellular core unit.

18. A radio terminal equipment arrangement comprising a cellular core unit and at least one peripheral unit,
the cellular core unit comprising:
a control unit for controlling functions of the cellular core unit; and
a transceiver for communicating with the at least one peripheral unit by using a wireless low power radio frequency (LPRF) connection,
the peripheral unit comprising:
a control unit for controlling functions of the peripheral unit; and
a transceiver for communicating with the cellular core unit,
wherein:
the control unit for controlling the functions of the cellular core unit is configured to send cellular related information to the peripheral unit when an application requiring a cellular connection is active in the peripheral unit, and to interrupt sending of the cellular related information to the peripheral unit when the application requiring cellular connection is inactive in the peripheral unit, and
the control unit for controlling the functions of the peripheral unit is configured to notify cellular related information in the peripheral unit based on the received cellular related information from the cellular core unit.

19. The radio terminal equipment arrangement of claim 18, wherein the control unit for controlling the functions of the cellular core unit is configured to detect when the application requiring cellular connection is active in the peripheral unit based on communication between the peripheral unit and the cellular core unit.

20. The radio terminal equipment arrangement of claim 18, wherein the control unit for controlling the functions of the cellular core unit is further configured to detect a change in cellular connection quality, and to send the cellular related information when a change in cellular connection quality has been detected.

21. A radio terminal equipment arrangement comprising a cellular core unit and at least one peripheral unit,
the cellular core unit comprising:
a control unit for controlling functions of the cellular core unit; and
a transceiver for communicating with the at least one peripheral unit by using a wireless low power radio frequency (LPRF) connection,
the peripheral unit comprising:
a control unit for controlling functions of the peripheral unit; and
a transceiver for sending a message for requesting cellular related information to the cellular core unit when an application requiring a cellular connection is activated by the peripheral unit,
wherein:
the control unit for controlling the functions of the cellular core unit is configured to send cellular related information to the peripheral unit when the message for requesting cellular related information has been received, and
the control unit for controlling the functions of the peripheral unit is configured to notify cellular related information in the peripheral unit based on the received cellular related information from the cellular core unit.

22. The radio terminal equipment arrangement of claim 21, wherein the control unit for controlling the functions of the cellular core unit is further configured to send cellular related information periodically to the peripheral unit when the message for requesting cellular related information has been received in the cellular core unit.

23. The radio terminal equipment arrangement of claim 21, wherein the control unit for controlling the functions of the peripheral unit is further configured to send a message for pausing the sending of the cellular related information to the cellular core unit when the peripheral unit enters an inactive mode.

24. The radio terminal equipment arrangement of claim 23, wherein the control unit for controlling the functions of the peripheral unit is further configured to send a message for continuing the sending of the cellular related information to the cellular core unit when the inactive mode ends.

25. The radio terminal equipment arrangement of claim 21, wherein the control unit for controlling the functions of the peripheral unit is further configured to send a message for pausing the sending of the cellular related information to the cellular core unit when the application requiring a cellular connection enters an inactive mode.

26. The radio terminal equipment arrangement of claim 21, wherein the control unit for controlling the functions of the peripheral unit is further configured to send a message for stopping the sending of the cellular related information to the cellular core unit when the application requiring a cellular connection is closed.

27. The radio terminal equipment arrangement of claim 21, wherein the cellular related information is in an RSSI (Receiving Signal Strength Indicator) message, the RSSI message comprising cellular field strength data, and the control unit for controlling the functions of the peripheral unit is further configured to notify cellular field strength data based on the received RSSI message.

28. A radio terminal equipment arrangement comprising a cellular core unit and at least one peripheral unit,
the cellular core unit comprising:
a control unit for controlling functions of the cellular core unit; and
a transceiver for communicating with the at least one peripheral unit by using a wireless low power radio frequency (LPRF) connection,
the peripheral unit comprising:
a control unit for controlling functions of the peripheral unit; and
a transceiver for communicating with the cellular core unit,
wherein:
the control unit for controlling the functions of the cellular core unit is configured to send cellular related information to the peripheral unit when an application requiring a cellular connection is active in the peripheral unit and a command message for requesting the cellular related information is received in the cellular core unit, and to interrupt the sending of the cellular related information to the peripheral unit when a command message for interrupting the sending of the cellular related information is received in the cellular core unit, and
the control unit for controlling the functions of the peripheral unit is configured to notify cellular related information in the peripheral unit based on the received cellular related information from the cellular core unit.

29. A cellular core unit of a radio terminal equipment arrangement, comprising:
communicating means for communicating with at least one peripheral unit of the radio terminal equipment arrangement by using a wireless low power radio frequency (LPRF) connection; and
controlling means for:
controlling functions of the cellular core unit,
sending cellular related information to the peripheral unit, when an application requiring a cellular connection is active in the peripheral unit, and
interrupting the sending of the cellular related information to the peripheral unit when the application requiring a cellular connection is inactive in the peripheral unit.

30. The cellular core unit of claim 29, wherein the controlling means are configured to detect when the application requiring a cellular connection is active in the peripheral unit based on communication between the peripheral unit and the cellular core unit.

31. The cellular core unit of claim 29, wherein the controlling means are further configured to detect a change in cellular connection quality, and to send the cellular related information when a change in cellular connection quality has been detected.

32. A cellular core unit of a radio terminal equipment arrangement, comprising:
controlling means for controlling functions of the cellular core unit; and
communicating means for:
communicating with at least one peripheral unit of the radio terminal equipment arrangement by using a wireless low power radio frequency (LPRF) connection;
receiving a message for requesting cellular related information from the peripheral unit; and
sending cellular related information to the peripheral unit when the message for requesting cellular related information has been received.

33. The cellular core unit of claim 32, wherein the cellular related information is in an RSSI (Receiving Signal Strength Indicator) message, the RSSI message comprising cellular field strength data.

34. A cellular core unit of a radio terminal equipment arrangement, comprising:
communicating means for communicating with at least one peripheral unit of the radio terminal equipment arrangement by using a wireless low power radio frequency (LPRF) connection; and
controlling means for:
controlling functions of the cellular core unit,
sending cellular related information to the peripheral unit, when an application requiring a cellular connection is active in the peripheral unit and a command message for requesting the cellular related information is received in the cellular core unit, and
interrupting the sending of the cellular related information to the peripheral unit when a command message for interrupting the sending of the cellular related information is received in the cellular core unit.

35. A peripheral unit of a radio terminal equipment arrangement, comprising:
controlling means for controlling functions of the peripheral unit, and
communicating means for communicating with a cellular core unit of the radio terminal equipment arrangement by using a wireless low power radio frequency (LPRF) connection,
wherein:
the communicating means are further configured to receive cellular related information from the cellular core unit when an application requiring cellular connection is active in the peripheral unit and to interrupt sending of the cellular related information to the peripheral unit when the application requiring a cellular connection is inactive in the peripheral unit, and
the controlling means are configured to notify cellular related information in the peripheral unit based on the received cellular related information from the cellular core unit.

36. The peripheral unit of claim 35, wherein the controlling means are further configured to send a message for requesting cellular related information to the cellular core unit when the application requiring a cellular connection is activated in the peripheral unit.

37. A peripheral unit of a radio terminal equipment arrangement, comprising:
controlling means for controlling the functions of the peripheral unit, and
communicating means for:
communicating with a cellular core unit of the radio terminal equipment arrangement by using a wireless low power radio frequency (LPRF) connection; and
sending a message for requesting cellular related information to the cellular core unit when an application requiring a cellular connection is activated by the peripheral unit,
wherein:
the controlling means are further configured to notify cellular related information based on the received cellular related information from the cellular core unit.

38. The peripheral unit of claim 37, wherein the communicating means are further configured to send a message for pausing the sending of the cellular related information to the cellular core unit when an inactive mode is entered by the peripheral unit.

39. The peripheral unit of claim 37, wherein the communicating means are further configured to send a message for stopping the sending of the cellular related information to the cellular core unit when the application requiring a cellular connection is closed.

40. The peripheral unit of claim 37, wherein the cellular related information is in an RSSI (Receiving Signal Strength Indicator) message, the RSSI message comprising cellular field strength data, and the controlling means are further configured to notify cellular field strength data in the peripheral unit based on the received RSSI message.
